(19) United States
(12) Patent Application Publication
(10) Pub. No.: US 2007/0172284 A1
(43) Pub. Date: Jul. 26, 2007

(54) Image forming apparatus, image forming method and image forming program

(75) Inventor: Yasumasa Tsukamoto, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/586,695

(22) Filed: Oct. 26, 2006

(30) Foreign Application Priority Data
Jan. 17, 2006 (JP) JP2006-008526

(51) Int. Cl. B41J 11/44

(52) U.S. Cl. 400/76

(57) ABSTRACT

An image forming apparatus, including an image forming section to form a cover image on a cover sheet to cover bundled printing sheets with the cover sheet folded in a U-shape, based on image data of the cover sheet, and a control section to determine a cover image forming area of the cover image to be arranged on the cover sheet based on a size of the printing sheet and a width of a spine cover, and to control the image forming section to form the cover image on the cover image forming area based on the image data of the cover sheet.

This application is based on Japanese Patent Application No. 2006-008526 filed on Jan. 17, 2006, in the Japanese Patent Office, the entire content of which is hereby incorporated by reference.

### TECHNICAL FIELD

The present invention relates to an image forming apparatus and a program used in the same image forming apparatus which forms images on a cover sheet prior to book-binding.

### BACKGROUND

For book-binding, there are some well known image forming apparatus in which the width of a spine is taken into account when images for a front cover and images for a back cover are arranged on a U-shaped cover sheet to cover bundled printed sheets (Patent Documents 1 and 2).

Patent Document 1 discloses that the width of the spine is provided between the images for a front cover and the images for a back cover, and that those images are arranged based on the corner of the cover sheet.

Patent Document 2 discloses that an area for a spine cover, which is the width of the spine cover, is arranged on the center of the cover sheet, and that the image forming area on the front cover and the image forming area on the back cover are arranged on both sides of the spine cover area, and the images for the front cover and the images for the back cover are arranged on the center of the image forming area on the front cover and the image forming area on the back cover, respectively.

[Patent Document 1] Unexamined Japanese Patent Application Publication 2000-332987

[Patent Document 2] Unexamined Japanese Patent Application Publication 2000-261656

In Patent Document 1, the width of the spine is provided based on the corner of the cover sheet, and the images for the front cover and the images for the back cover are arranged on the cover sheet. Accordingly, if the size of the printing sheets differs to the image sizes of the front and back covers, the spine cover area will not be centered on the cover sheet. That is, when the book is formed, the problem occurs that the front cover image, the back cover image and the spine cover image are not be arranged in their proper positions.

Further, when the cover sheet is cut to the size of the printing sheets, as discussed in Patent Document 2, based on the cover sheet size before cutting, the front cover image and the back cover image are arranged onto the center of the front cover image forming area and the center of the back cover image forming area, respectively. Accordingly, when the cover sheet is cut, parts of the front cover image and the back cover image may be cut off, or the spine cover may be in the wrong position.

### SUMMARY

The present invention has been achieved in view of the above problems. An object of the present invention is to provide an image forming apparatus, wherein the cover images are formed at the proper position on the cover sheet without depending on an inputted cover image size or a cover sheet size, and further the produced book has good appearance.

An image forming apparatus of the present invention includes:

an image forming section to form a cover image on a U-shaped folded cover sheet to cover printing sheets, based on image data of the cover sheet; and

a control section to determine a cover image forming area of the cover image to be arranged on a cover sheet, based on a size of the printing sheets and the width of a spine cover, and to control the image forming section to form the cover image on the cover image forming area based on the cover image data.

An image forming method of the present invention includes the steps of:

obtaining cover sheet data to form a cover image on a cover sheet;

obtaining a size of printing sheets to be covered by the cover sheet, folded in a U-shape;

obtaining a width of a spine cover;

establishing a cover image forming area based on the size of the printing sheets and the width of the spine cover; and

forming the cover image on the cover image forming area established by the step of establishing a cover image forming area based on the cover image data.

A program of the present invention includes the steps of:

obtaining cover sheet data to form a cover image on a cover sheet;

obtaining a size of printing sheets to be covered by the cover sheet folded in a U-shape;

obtaining a width of a spine cover;

establishing a cover image forming area based on the size of the printing sheets and the width of the spine cover; and

forming the cover image on the cover image forming area by the step of establishing a cover image forming area based on the cover image data.

Based on the present invention, the area for forming the cover image is determined based on the size of the printing sheets and the width of the spine cover, and the cover image is arranged on the area. Accordingly, the cover images are formed at their proper position on the cover sheet without depending upon an inputted cover image size or the cover sheet size, and further a book of good appearance can be provided.

### BRIEF DESCRIPTION OF THE DRAWINGS

FIG. 1 is a block diagram showing the structure of the image forming apparatus relating to the present embodiment.

FIG. 2 is a flow chart showing the cover image forming process relating to the present embodiment.

FIG. 3 is a flow chart showing the image position determining process relating to the present embodiment.

FIG. 4 shows a layout of front cover image forming area “a”, back cover image forming area “b” and spine cover image forming area “c”.

FIG. 5 shows an example of positioning of front cover image A and back cover image B.

FIG. 6 shows an example of the finalized arrangement of the cover images positioned on the cover sheets.

### DETAILED DESCRIPTION OF THE PREFERRED EMBODIMENT

### (System Structure)

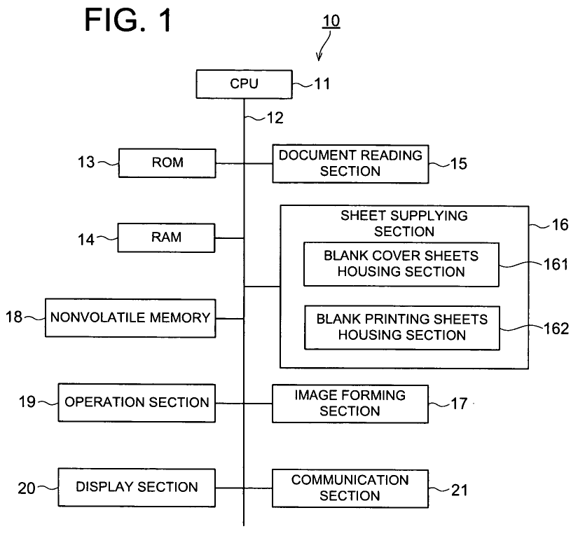

FIG. 1 is a block diagram showing the structure of the image forming apparatus relating to the present embodiment.

In image forming apparatus 10, CPU 11, serving as a control section to perform various controls of image forming apparatus 10, is provided to which ROM 13, RAM 14, document reading section 15, sheet supplying section 16, image forming section 17, nonvolatile memory 18, operation section 19, display section 20, and communication section 21 are inter-connected each other through bus 12.

ROM 13 stores various operational programs and data, and CPU 11 controls image forming apparatus 10 by using the various operational programs and data.

RAM 14 is used by CPU 11 as a working area, and RAM 14 temporarily memorizes the operational programs and the data which are necessary for CPU 11 to control image forming apparatus 10.

Document reading section 15 reads out the original image document to create the image data, which is then outputted to image forming section 17.

Sheet supplying section 16 includes cover sheet housing section 161 which accommodates the blank cover sheets and printing sheet housing section 162 to accommodate the blank printing sheets, and supplies the blank cover sheet or the blank printing sheet to image forming section 17.

Image forming section 17 performs the image formation on the blank printing sheets or on the blank cover sheet, based on the image data inputted from document reading section 15.

Nonvolatile memory 18 memorizes the size of the cover sheets housed in cover sheet housing section 161, as well as the size of the sheets housed in printing sheet housing section 162.

Operation section 19 is used by the operator, to input the setting of the width of the spine cover, the setting of cover sheets housing section, the setting of the printing sheets housing section, and the start-print instruction.

Display section 20 exhibits the screens for various operations and settings. A structure is also possible so that display section 20 is formed of a touch-panel, and which also serves as operation panel 19.

Communication section 21 is an interface for communicating with the external devices, and further receives the image data sent from the personal computer.

### (Cover Image Forming Process)

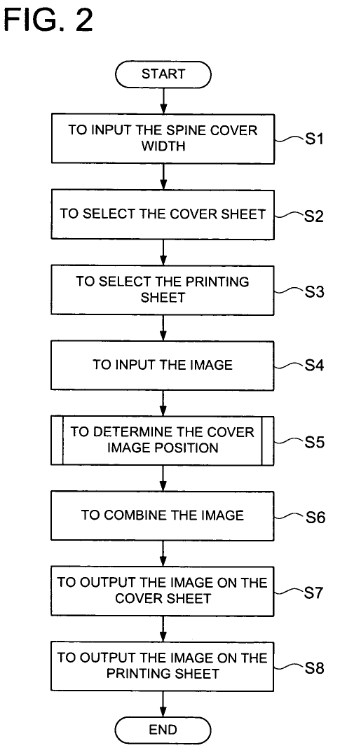

FIG. 2 is a flow chart showing the cover image forming process relating to the present embodiment. Since this is an example, the process is not limited to it. This process is performed by CPU 11 based on the programs stored in ROM 13.

Firstly, CPU 11 displays a spine cover width input screen on display section 20. According to the displayed screen, the operator enters the width of the spine cover through operation section 19, which in turn inputs the width of the spine cover in CPU 11 (step S1).

Further, CPU 11 displays a cover sheet selection screen on display section 20. Then the operator selects, via operation section 19, the sheet housing section in which the blank cover sheets are stored, to input information of the cover sheet housing section in CPU 11 (step S2).

Subsequently, CPU 11 displays a printing sheet selection screen on display section 20. The operator selects, via operation section 19, the printing sheet housing section in which the blank printing sheets are housed, to input information of the printing sheet housing section (step S3).

Continuing, the operator places the original documents on document reading section 15, and orders start-print via operation section 19. CPU 11 drives document reading section 15 to obtain the original document images (step S4). The obtained digital document images are stored in RAM 14. In this case, the front cover original document, the printing sheets original documents and the back cover original document are stacked by this order, and are set in document reading section 15 to be read, after which they are inputted into CPU 11 as a group of original document images.

Then, CPU 11 determines the position of the cover image (step S5) based on information inputted in steps S1-S4, as will hereinafter be described in detail.

CPU 11 then places the inputted images at the image position obtained in step S5, to create the cover image, in which the front cover image and the back cover image are combined (step S6). The created cover images are stored in RAM 14, which functions as a page memory.

Next, CPU 11 orders sheet supplying section 16 to supply the blank cover sheet from the cover sheet housing section which was selected in step S2. CPU 11 also orders image forming section 17 to form the created cover images, which were obtained in step S6, on the supplied blank cover sheet (step S7). Via this procedure, the cover images are formed on the blank cover sheet.

Finally, CPU 11 orders sheet supplying section 16 to supply the blank printing sheets from the printing sheet housing section which was selected in step S3. CPU 11 also orders image forming section 17 to form the images onto the supplied blank printing sheet (step S8). By this procedure, the images are formed on the blank printing sheets.

### (Cover Image Position Determining Process)

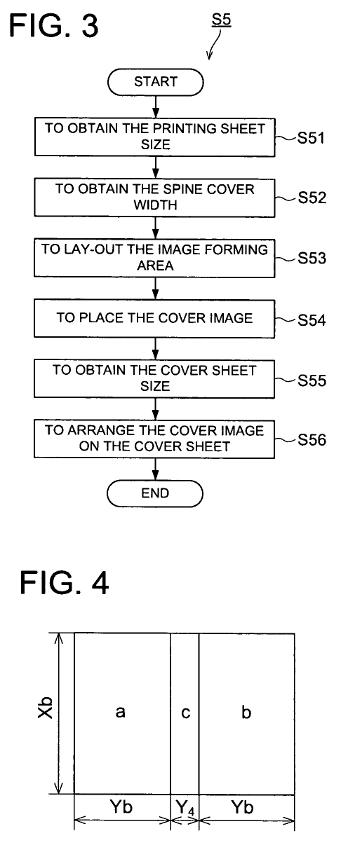

FIG. 3 is a flow chart showing the cover image position determining process in step S5 of FIG. 2. Since this is an example, the process is not limited to it, and this process is performed by CPU 11 based on the programs stored in ROM 13.

Firstly, CPU 11 specifies printing sheet housing section 162 based on information of the printing sheet housing section selected in step S3 of FIG. 2. CPU 11 reads out the size of the printing sheet corresponding to specified printing sheet housing section 162, from nonvolatile memory 18 (step S51 of FIG. 3). This printing sheet size becomes the size of the front cover image forming area, as well as the size of the back cover image forming area.

Further, CPU 11 obtains the spine cover width which was selected in step S1 of FIG. 2 (step S52).

Subsequently, CPU 11 performs the lay-out operation in which spine cover area “c” is positioned between front cover image forming area “a” and back cover image forming area “b”, based on the printing sheet size obtained in step S51 and the spine cover width obtained in step S52, as shown in step S53 of FIG. 4. In FIG. 4, the printing sheet size is shown as Xb and Yb, while the spine cover width is shown as Y4. By this lay-out, when the book is formed, the position of the spine cover can not shift, and the cover images are formed at the proper positions on the cover sheet.

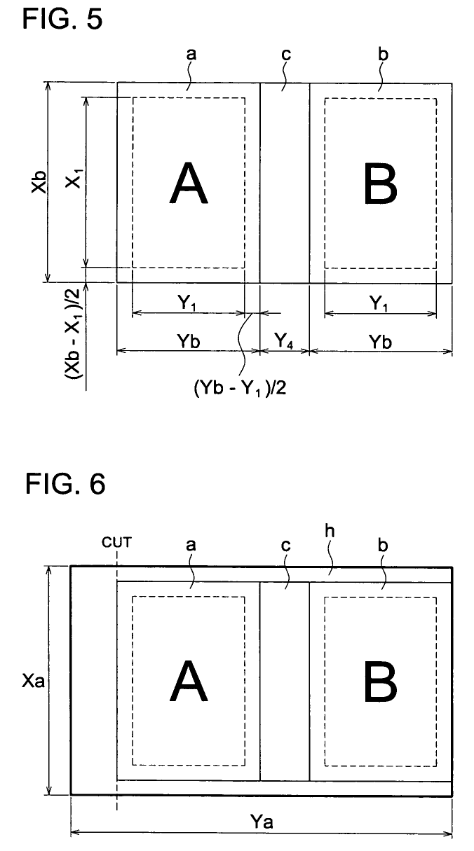

Continuing, CPU 11 places the front cover image and the back cover image, both of which were inputted in step S4 of FIG. 2, onto above laid-out front cover image forming area “a” and back cover image forming area “b” (step S54). For example, as shown in FIG. 5, positioning is conducted in such a way that the center of front cover image A and the center of back cover image B are properly placed at the center of front cover image forming area “a” and the center of back cover image forming area “b”, respectively, that is, positioning is conducted based on each center, which results in good overall appearance, while each image of the front cover and the back cover is positioned at the center of each cover. FIG. 5 shows that image size (X1, Y1) of front cover image A and back cover image B is smaller than the size of printing sheet (Xb, Yb). In FIG. 5, front cover image A and back cover image B are positioned at the center of front cover image forming area “a”, and the center of back cover image forming area “b”, respectively. However, positioning is not limited to this, and shifting to any side is also possible.

Then, CPU 11 specifies cover sheet housing section 161 based on information of the cover sheet housing section which was selected and inputted in step S2 of FIG. 2, and reads out to obtain the size of the cover sheet corresponding to specified cover sheet housing section 161 from nonvolatile memory 18 (step S55).

Finally, CPU 11 determines (step S56) where the cover image arranged in step S54 is to be placed on the area of the cover sheet size obtained in step S55. For example, as shown in FIG. 6, the arranged cover image is placed while shifted to one side of cover sheet size area “h” (that is, the one side means an end section of a book). FIG. 6 shows a case in which placed cover image size (Xb, Yb+Yb+Y4) is smaller than cover sheet size (Xa, Ya). When trimming of the cover sheet is conducted, the cover sheet is normally cut at a position shown in FIG. 6, therefore, front cover image forming area “a” or back cover image forming area “b” is not cut, and the image formed on the cover sheet is not damaged.

As described above, based on the present embodiment, the area on which the cover image is to be formed is determined based on the printing sheet size and the spine cover width, and the cover image is arranged within this area. Accordingly, the spine cover is not shifted on the produced book, and the cover images are properly formed on the overall cover sheet. Further, while trimming the cover sheet, neither front cover image forming area “a” nor back cover image forming area “b” is cut, and the images formed on the cover sheet are not damaged.

In the present embodiment, as shown in FIG. 5, image size (X1, Y1) of front cover image A and back cover image B is smaller than the size of printing sheet (Xb, Yb). However, it is also possible to make image size (X1, Y1) of front cover image A and back cover image B to be larger than the size of printing sheet (Xb, Yb). That is, in the same way as FIG. 5, front cover image A and back cover image B can be placed at each center of front cover image forming area “a” and back cover image forming area “b”, respectively. Further, it is also possible to place the major portions of front cover image A and back cover image B to be included within front cover image forming area “a” and back cover image forming area “b”.

Further, in the present embodiment, no image formation was conducted on the spine cover. However, it is also possible to input an image for the spine cover to form a spine image in the spine cover area.

Yet further in the present embodiment, the images were inputted from document reading section 15, but can also be inputted form external devices, such as a personal computer, through communication center 21.

Still further, in the present embodiment, the cover image position was determined on the program stored in image forming apparatus 10, but can also be determined based on a program of a printer driver installed in external devices, such as a personal computer, after the image data is formed by the external devices.

What is claimed is:

1. An image forming apparatus, comprising:
an image forming section to form a cover image on a cover sheet to cover bundled printing sheets with the cover sheet folded in a U-shape, based on image data of the cover sheet; and
a control section to determine a cover image forming area of the cover image to be arranged on the cover sheet based on a size of the printing sheet and a width of a spine cover, and to control the image forming section to form the cover image on the cover image forming area based on the image data of the cover sheet.

2. The image forming apparatus in claim 1, wherein the cover image forming area includes a front cover image forming area and a back cover image forming area, between which a spine cover area is arranged.

3. The image forming apparatus in claim 2, wherein the front cover forming area and the back cover forming area are determined based on one side which represents an end section of a book which is produced of the bundled printing sheets covered with the cover sheet folded in the U-shape.

4. The image forming apparatus in claim 2, wherein a size of the front cover image forming area and a size of the back cover forming area are equal to a size of the bundled printing sheets.

5. The image forming apparatus in claim 1, wherein the control section controls the image forming section to form a front cover image and a back cover image to be placed at a center of the front cover image forming area and at a center of the back cover image forming area, respectively.

6. A cover image forming method, comprising the steps of:
obtaining cover sheet data to form a cover image on a cover sheet;
obtaining a size of bundled printing sheets to be covered by the cover sheet folded in a U-shape;
obtaining a width of a spine cover;
establishing a cover image forming area based on the size of the bundled printing sheets and the width of the spine cover; and
forming the cover image on the cover image forming area by the step of establishing the cover image forming area based on cover image data.

7. A program for working a computer, comprising the steps of:
obtaining cover sheet data to form a cover image on a cover sheet;
obtaining a size of bundled printing sheets to be covered by the cover sheet folded in a U-shape;
obtaining a width of a spine cover;
establishing a cover image forming area based on the size of the bundled printing sheets and the width of the spine cover; and
forming the cover image on the cover image forming area established by the step of establishing the cover image forming area based on cover image data.
